(19) United States
(12) Patent Application Publication
(10) Pub. No.: US 2021/0114094 A1
(43) Pub. Date: Apr. 22, 2021

(54) PRODUCTION OF A BULK METALLIC GLASS COMPOSITE MATERIAL USING A POWDER-BASED ADDITIVE MANUFACTURE

(71) Applicant: HERAEUS ADDITIVE MANUFACTURING GMBH, Hanau (DE)

(72) Inventor: Moritz Stolpe, Hanau (DE)

(21) Appl. No.: 16/981,897

(22) PCT Filed: Feb. 1, 2019
(86) PCT No.: PCT/EP2019/052503

§ 371 Date: Sep. 17, 2020

(30) Foreign Application Priority Data
Mar. 20, 2018 (EP) 18162718.3

(51) Int. Cl. B22F 3/00; B22F 10/28; B33Y 80/00; B33Y 70/00; B33Y 10/00

(52) U.S. Cl. CPC B22F 3/006; B22F 10/28; B22F 1/0048; B33Y 70/00; B33Y 10/00; B33Y 80/00

(57) ABSTRACT

The invention relates to a method for producing a bulk metallic glass composite material. The bulk metallic glass composite material has at least two phases, wherein the first phase is a bulk metallic glass, and at least one other phase is selected from the group consisting of crystalline metal, metallic glass, non-metallic glass, and ceramic. The invention is characterized in that the production is carried out using a powder-based additive manufacturing process.

The present invention relates to a method for the production of a bulk metallic glass composite material by means of a powder-based, additive manufacturing method and a bulk metallic glass composite material produced by means of said method. Further, the invention concerns a three-dimensional component manufactured from the composite material according to the invention.

Since their discovery about 50 years ago at the California Institute of Technology, metallic glasses have been the subject matter of extensive research. Over the years, it has been possible to continuously improve the processability and properties of this material class. While the first metallic glasses were still simple, binary (constructed from two components) alloys, whose production required cooling rates in the area of 10⁶ Kelvin per second (K/s), newer, more complex alloys can already be converted into the glassy state with significantly lower cooling rates in the area of a few K/s. This has a considerable influence on the process management as well as the feasible components. The cooling speed from which a crystallization of the melt fails to occur and the melt solidifies as glass is called the critical cooling rate. It is a system-specific value, strongly dependent on the composition of the melt, which also determines the maximum achievable component thicknesses. If one considers that the heat energy stored in the melt must be transported sufficiently quickly through the system, it is clear that only components with low thickness can be manufactured from systems with high critical cooling rates. Initially, metallic glasses were therefore usually manufactured according to the “melt spinning” method. Here, the melt is stripped off onto a rotating copper wheel and solidifies in a glass-like manner in the form of thin bands or films with thicknesses in the area of a few hundredths to a few tenths of a millimeter. Through the development of new, complex alloys with significantly lower critical cooling rates, other production methods can increasingly be used. The glass-forming metallic alloys of today can already be converted into the glassy state by casting of a melt into cooled copper molds. The feasible component thicknesses are in the area of a few millimeters to a few centimeters, depending on the alloy. Such alloys are referred to as bulk metallic glasses (BMG). Today, a variety of such alloy systems are known. They are usually subdivided based upon the composition, wherein the alloy element having the highest proportion by weight is referred to as the base element. The existing systems include, for example, precious metal-based alloys such as gold, platinum, and palladium-based bulk metallic glasses, early transition metal-based alloys such as titanium or zirconium-based bulk metallic glasses, late transition metal-based systems based upon copper, nickel, or iron, but also systems based upon rare earths, e.g., neodymium or terbium.

Bulk metallic glasses typically feature the following properties in comparison to classic crystalline metals:
a higher specific strength, which allows, for example, thinner wall thicknesses,
a greater hardness, whereby surfaces can be particularly scratch-resistant,
a much higher elastic stretchability and resilience,
a thermoplastic formability, and
a higher corrosion resistance.

Bulk metallic glasses may also have disadvantages, depending upon the application.

For example, bulk metallic glasses often show brittle, catastrophic material failure under tension loads. Specific material applications of bulk metallic glasses therefore often contain requirements that individual monolithic, bulk metallic glasses cannot meet or can only partially meet.

Composite materials that contain the bulk metallic glasses in combination with additional material components can provide a remedy here. By combining two or more starting materials into a composite material, the property profiles of the starting materials can be combined in one material. As a result, the composite material has a property profile that differs significantly from that of the individual materials. Therefore, composite materials can enable a targeted adjustment of the electrical, magnetic, thermal, mechanical, or other properties to the respective requirements.

### PRIOR ART

Conventional methods in order to manufacture components made from bulk metallic glasses are casting methods. These are also partly used for bulk metallic glass composite materials. From the prior art, various methods are known, with which bulk metallic glass composite materials can be produced. These include, among others, the precipitation method, various casting methods, severe plastic deformation (SPD), and hot isostatic pressing (HIP).

Precipitation methods are known, for example, from Scientific Reports 3:2097 (DOI: 10.1038/srep02097). Here, zirconium precipitations of the melt are described in order to remove and bind oxygen from a metallic glass matrix. From the Journal of Materials Volume 2013, Article ID 517904, (Title: “Bulk Metallic Glasses and Their Composites: A Brief History of Diverging Fields”), various alloys are known which form dendritic precipitates in a bulk metallic glass matrix during cooling.

From Science, vol. 329, No. 5997, 2010, p. 1294-1295, various bulk metallic glass composite materials are known that have dendritic structures and are manufactured by means of melt casting. From the dissertation entitled “Bulk metallic glass composites,” (ETH Zurich, 2007, https://doi.org/10.3929/ethz-a-005348591), bulk metallic glass composites are known that are strengthened with graphite particles. As a matrix, the commercially available alloy Vitralloy 105 is used here. Composite materials that have a bulk metallic glass and a non-metallic component are known from CN101967613B.

Scientific Reports, 7: 6651 (DOI:10.1038/s41598-017-06424-4) discloses bulk metallic glass composite materials, which are produced by means of high-pressure torsion (HPT). HPT is a method in which a powder mixture is exposed to extremely high shearing forces, whereby the powder particles combine. The HPT method is also called the SPD method. Starting with powders of a zirconium-based bulk metallic glass and crystalline copper particles, bulk metallic glass composite materials are generated through HPT. It is described that it is thus possible to produce amorphous/crystalline composite materials in which the sizes of the respective phases can be varied from the micrometer range to the nanometer range. Metallic glass phases with an oblong shape and an expansion along the shear direction of 100 μm and width of 10 μm orthogonally to the shear direction are observed.

U.S. Pat. No. 7,361,239B2 discloses bulk metallic glass composite materials, which combine a metallic glass with the crystalline refractory metal tungsten. Hot isostatic pressing (HIP) of metal powders is used for the production.

The prior art has several disadvantages. For example, the precipitation route requires an adjustment of the alloy in such a way that there is a precipitation of a primary phase without a reduction of the glass formation capability of the residual melt so that there is no longer a formation of an amorphous matrix. As a result, the material selection for the production of components is very limited in this method. The achievable geometries of the components are limited by the glass formation capability and through restrictions of conventional production methods, e.g., the cooling speed during the mold casting method.

In the casting route, the only combinations that can be realized are those in which an additional phase has a significantly higher melting point or a lower solubility than the glass-forming phase, because there would otherwise be a dissolving of the additional phase in the melt of the glass-forming phase. This can either lead to an undesirable change in the properties of the glass-forming phase, or it can even lead to the glass formation properties of the glass-forming phase being completely lost. This production method for bulk metallic glass composites is thus limited to material combinations that have widely distanced melting temperatures.

Hot isostatic pressing has the disadvantage that the method is only suitable for components that allow significantly broader component tolerances than can be achieved with other metallurgical methods, e.g., suction casting or pressure casting. A precise setting of the dimensions of the finished component is either not at all possible or else only possible with extreme effort. Further, it is not possible to manufacture 3D objects with complex geometries from one piece, because, for example, components with undercuts and cavities can no longer be removed from the mold without destroying the component or the shape.

The problem of the invention was to provide an improved method for the production of a bulk metallic glass composite material that overcomes one or more disadvantages of the prior art.

In particular, a problem was to provide a bulk metallic glass composite material that has isotropic mechanical properties.

A further preferred problem consisted of providing a method for the production of a bulk metallic glass composite material that has mechanical properties that can be adjusted over wide areas.

A further preferred problem consisted of providing a method that allows for three-dimensional components to be produced from a bulk metallic glass composite material, wherein the components have complex geometries. Complex component geometries may be, in particular, structures that have at least one of the following properties:
undercuts or interior cavities,
geometries with large aspect ratios (e.g., length to diameter, length to width, length to thickness),
components with integrated channels or ducts, and
network or grid structures, in particular percolating networks.

A further task was to provide a method with which three-dimensional components can be produced that have dimensions that are larger than the maximum producible cast thickness. The maximum cast thickness results from the critical cooling rate of a material, among other things. If the critical cooling rate is undershot, the glass-forming alloy can be partially or completely crystallized.

Structures with a high aspect ratio, such as struts, cannot be produced by conventional mold casting (e.g., pressure or suction casting) due to the flowability of highly cooled, metallic melts, because, as a result of the rapid solidification of the melts that is necessary during the glass formation, there is a sharp increase in viscosity. Due to the increased viscosity, the melt cannot flow into narrow channels.

Further, there was a preferred problem in the provision of a bulk metallic glass composite material, wherein the material has isotropic mechanical properties. Isotropic material properties may simplify the construction of three-dimensional components, because the local mechanical properties are more predictable.

A further preferred problem consisted of providing a three-dimensional component containing a bulk metallic glass composite material, wherein the bulk metallic glass composite material has at least two phases whose melting points are no more than 200° C., in particular no more than 150° C., apart from one another.

### DESCRIPTION OF THE INVENTION

At least one of the aforementioned tasks is solved by a method for the production of a bulk metallic glass composite material, wherein the bulk metallic glass composite material has at least two phases, wherein the first phase is a bulk metallic glass and wherein at least one additional phase is selected from the group consisting of crystalline metal, metallic glass, non-metallic glass, and ceramic,

characterized in that the production occurs by means of a powder-based, additive manufacturing method.

A composite material is also called a composite and is a material consisting of two or more material components connected to each other, wherein the composite material has different material properties than its individual components. Within the scope of the invention, the connected materials of the composite material are also referred to as phases. A phase is a spatial area in a material system in which the determining physical parameters and the chemical composition of the matter are homogeneous.

The bulk metallic glass composite material has a first phase and at least one additional phase. The first phase contains a bulk metallic glass or consists of a bulk metallic glass. In particular, the first phase is a continuous phase, i.e., a contiguous phase, which can also be referred to as a matrix in this context. An additional phase may be dispersed in the continuous first phase. In an alternative embodiment, the first phase may also be discontinuously present in the bulk metallic glass composite material, i.e., interrupted in multiple separate areas.

Bulk metallic glasses are understood to be alloys that have a metallic bonding character and simultaneously an amorphous, i.e., non-crystalline, phase. The bulk metallic glasses may be based upon different elements. “Based” in this context means that the respectively named element constitutes the largest portion with respect to the weight of the alloy. Typical components that preferably also constitute the base of the alloy may be selected from:
A. metals from group 11 and IIA of the periodic table, e.g., magnesium, calcium,
B. metals from group IIIA and IVA of the periodic table, e.g., aluminum or gallium,
C. early transition metals from the groups IVB to VIIIB of the periodic table, such as titanium, zirconium, hafnium, niobium, tantalum, chrome, molybdenum, manganese,
D. late transition metals from the groups VIIIB, IB, IIB of the periodic table, such as iron, cobalt, nickel, copper, palladium, platinum, gold, silver, zinc,
E. rare earth metals, such as scandium, yttrium, terbium, lanthanum, cerium, neodymium, gadolinium, and
F. non-metals, such as boron, carbon, phosphorus, silicon, germanium, sulfur

Preferred combinations of elements in bulk metallic glasses are selected from:
Late transition metals and non-metals, wherein the late transition metal constitutes the base, for example Ni—P, Pd—Si, Au—Si—Ge, Pd—Ni—Cu—P, Fe—Cr—Mo—P—C—B
Early and late transition metals, wherein both metals may constitute the base, such as Zr—Cu, Zr—Ni, Ti—Ni, Zr—Cu—Ni—Al, Zr—Ti—Cu—Ni—Be
Metals from group B with rare earth metals, wherein metal B constitutes the base, such as Al—La, Al—Ce, Al—La—Ni—Co, La—(Al/Ga)—Cu—Ni
Metals from group A with late transition metals, wherein metal A constitutes the base, such as Mg—Cu, Ca—Mg—Zn, Ca—Mg—Cu

Further particularly preferred examples for alloys that form bulk metallic glasses are selected from the group consisting of Ni—Nb—Sn, Co—Fe—Ta—B, Ca—Mg—Ag—Cu, Co—Fe—B—Si—Nb, Fe—Ga—(Cr,Mo)(P,C,B), Ti—Ni—Cu—Sn, Fe—Co-Ln—B, Co—(Al,Ga)—(P,B,Si), Fe—B—Si—Nb and Ni—(Nb,Ta)—Zr—Ti. In particular, the bulk metallic glass may be a Zr—Cu—Al—Nb alloy. In addition to zirconium, this Zr—Cu—Al—Nb alloy preferably has 23.5-24.5 wt. % copper, 3.5-4.0 wt. % aluminum, and 1.5-2.0 wt. % niobium, wherein the weight proportions add up to 100 wt. %. The last alloy mentioned is commercially available under the name AMZ4® from Heraeus Deutschland GmbH.

According to the invention, the bulk metallic glass composite material contains at least one additional phase. The at least one additional phase can be selected from a variety of materials. According to the invention, the at least one additional phase can be selected from the group consisting of crystalline metal, bulk metallic glass, non-metallic glass, and ceramic. Preferably, the at least one additional phase has a melting point which lies above the melting point of the first phase.

A crystalline metal is a classic metal known from materials science. The definition as a crystalline metal is only made in order to clarify that a bulk metallic glass—also called amorphous metal—is not at issue here. A crystalline metal has one or more crystalline areas with a long-range order and demonstrates a metallic behavior with regard to both the thermal and electrical conductivity. “Crystalline metals” are understood to mean pure metals as well as metal alloys here. In the powder according to the invention, a pure metal, several types of pure metals, a type of metal alloy, several types of metal alloys, or mixtures thereof can be contained as the metal. Within the scope of the invention, the term “pure metal” refers to an elementary chemical element which, in the periodic table of the elements, is in the same period as boron, but left of boron, in the same period as silicon, but left of silicon, in the same period as germanium, but left of germanium, and in the same period as antimony, but left of antimony, as well as to all elements that have an atomic number greater than 55.

Pure metals may also contain unavoidable impurities. The term “pure metals” does not rule out that the metal may have impurities. The total amount of impurities is preferably not more than 1 wt. %, in particular not more than 0.1 wt. %, and most preferably not more than 0.01 wt. %, with respect to the total amount of pure metal. In a particularly preferred embodiment, the pure metal does not contain any intentionally added elements.

In a preferred embodiment, the pure metal may be a precious metal. In a particularly preferred embodiment, the precious metal is a platinum metal, gold, or silver. The platinum metal may be selected from the group consisting of platinum, iridium, palladium, ruthenium, rhodium, and osmium.

In another preferred embodiment, the pure metal may be a refractory metal. The refractory metal may be selected in the context of the invention from elements of the 4th side group (e.g., titan, zirconium, and hafnium), the 5th side group (e.g., vanadium, niobium, and tantalum) as well as the 6th side group (e.g., chromium, molybdenum, and tungsten).

In a further preferred embodiment, the pure metal may be a non-ferrous metal or iron. The non-ferrous metal may be selected from the group consisting of cadmium, cobalt, copper, nickel, lead, tin, and zinc.

The metal may be a metal alloy according to one embodiment. Metal alloys are understood according to the invention to mean metallic mixtures of at least two elements, of which at least one is a metal. “Metallic” in this context means that there is predominantly a metallic bonding character among the elements involved.

In a preferred embodiment, the metal alloy may be a precious metal alloy. In a particularly preferred embodiment, the precious metal alloy contains an element selected from the group consisting of platinum metals, gold, and silver.

Preferred platinum metals in the precious metal alloys may be selected from the group consisting of platinum, iridium, palladium, ruthenium, rhodium, and osmium. In another preferred embodiment, the precious metal alloy may be an alloy of at least two of these platinum metals (e.g., platinum-iridium or platinum-rhodium alloys).

The metal alloy may preferably contain elements that are selected from refractory metals, non-ferrous metals, iron, and combinations of at least two of these metals.

Particularly preferred metal alloys may also be selected from aluminum alloys, copper alloys, nickel-based alloys, cobalt-based alloys, titanium-aluminum alloys, copper-tin alloys, stainless steel alloys, tool steel alloys, and super alloys for high-temperature applications.

Further, the at least one additional phase may be a bulk metallic glass with a different chemical composition and different physical properties than the first phase. For example, the first phase may be a zirconium-based bulk metallic glass and the at least one additional phase may be a titanium-based bulk metallic glass.

In another preferred embodiment, the additional phase may be a non-metallic glass. A non-metallic glass within the scope of the invention is understood to be an inorganic, amorphous material that has no metallic bonding character. The glasses may be oxidic glasses. Oxidic glasses may be selected from the group consisting of silicate glasses, borate glasses, and phosphate glasses. The names of these preferred oxidic glasses respectively indicate which component is most commonly present with respect to the weight. For example, silicate (SiO₄⁴⁻) is the most common component in silicate glasses. Each of the aforementioned types of glasses may contain additional elements as oxides, wherein these additional elements may preferably be selected from alkali metals, earth alkali metals, aluminum, boron, lead, zinc, and titanium.

In a possible embodiment of the invention, the at least one additional phase can be a ceramic. Ceramics within the context of the invention are understood to be crystalline, inorganic materials that do not have a metallic character. In a preferred embodiment, the ceramic may comprise natural minerals. For example, the ceramic may be selected from the group consisting of oxide ceramics, nitride ceramics, carbide ceramics, and mixed forms of at least two of these ceramics. The oxide ceramics may preferably comprise oxides of the elements that are selected from the group consisting of magnesium, calcium, aluminum, silicon, titanium, zirconium, and zinc. The oxide ceramic may comprise pure element oxides or mixed oxides. In a preferred embodiment, the element oxides are selected from the group consisting of magnesium oxide, calcium oxide, aluminum oxide, silicon oxide, titanium oxide, zirconium oxide, and zinc oxide. In another preferred embodiment, the mixed oxides contain at least two of the elements selected from the group consisting of magnesium, calcium, aluminum, silicon, titanium, zirconium, and zinc. Optionally, the mixed oxides may contain additional elements selected from the group consisting of the elements of the 3rd to 6th main group of the periodic table of the elements.

The bulk metallic glass composite material resulting from the method according to the invention comprises at least two phases, wherein the first phase is a bulk metallic glass and wherein at least one additional phase is selected from the group consisting of crystalline metal, bulk metallic glass, non-metallic glass, and ceramic. The resulting bulk metallic glass composite material may also comprise more than one additional phase, wherein each additional phase is selected from the group of materials of at least one additional phase.

Depending upon the required application, the following combinations of first phase and at least one additional phase may be preferred:
1) Combinations of bulk metallic glass and ductile, crystalline phase (e.g., Cu, Nb, Nb—Zr) may lead to improved ductility of the composite material.
2) Combinations of metallic glass and hard phase (e.g., W, WC, Sic) may lead to improved wear resistance.
3) Combinations of metallic glass and conductive material (e.g., copper or aluminum, as well as alloys of these metals) may lead to improved electrical or thermal conductivity.

Evidence that the bulk metallic glass composite material has a first amorphous phase can be provided, for example, by means of Differential Scanning calorimetry (DSC). When the bulk metallic glass composite material contains an amorphous phase, then an endothermic signal for the glass transition with increasing temperature, followed by an exothermic signal for the crystallization with further increasing temperature, can be observed in the DSC measurement. An endothermic signal means that the material, in particular the composite material, absorbs heat, while an exothermic signal means that the material, in particular the composite material, releases heat. This behavior in the DSC measurement can also be observed for the pure material of the first phase. By contrast, a crystalline metal shows no signals in the DSC that would be attributed to a glass transition or a crystallization. An amorphous phase can also be detected by electron microscopy (REM, TEM) as well as X-ray diffraction. In a preferred embodiment, a metallic glass is understood to mean a phase that is at least 50%, in particular at least 70%, and most preferably at least 90% amorphous.

The weight ratio between the first phase and at least one additional phase is not further limited according to the invention. Preferably, the proportion of the first phase is at least 50 wt. % or more, in particular 70 wt. % or more, and most preferably 90 wt. % or more. As a result, it can be achieved that the bulk metallic glass composite material retains as many of the advantageous properties of the pure bulk metallic glass as possible.

In an alternative embodiment, the weight proportion of the first phase in the entire bulk metallic glass composite material may be less than 50 wt. %, in particular less than 25 wt. %, and most preferably less than 10 wt. %. By setting different weight proportions of the first phase and at least one additional phase, the material properties of the available bulk metallic glass composite material can be adjusted in a targeted manner.

According to the invention, the bulk metallic glass composite material contains at least one additional phase. The at least one additional phase may be continuously or discontinuously present. When at least one additional phase is present discontinuously, a multitude of isolated areas of this additional phase are found in the matrix of bulk metallic glasses. When at least one additional phase is present continuously, it can form a network, in particular a network structure that is consistently connected. The at least one additional phase may be finely dispersed or agglomerated in the matrix of the first phase. Agglomerated means in this context that the areas of the at least one additional phase are at least partially in contact with one another.

Preferably, the bulk metallic glass composite material may have isotropic mechanical properties. Isotropic means that the material properties are independent of direction. Isotropic material properties may be obtained, in particular, when spherical or nearly spherical powders are used to generate the first phase and the at least one additional phase. This is a particular advantage of the method according to the invention in comparison to shearing methods (SPD), in which powder can be processed into bulk metallic glass composite material with very close melting temperatures, but with which no isotropic mechanical properties are achieved. This is particularly due to the direction of the shearing in such SPD methods.

Preferably, the first phase and at least one additional phase have melting temperatures that are no more than 200° C., in particular no more than 150° C. apart from each other. Particularly preferably, the at least one additional phase has a higher melting temperature than the first phase.

Preferably, the bulk metallic glass composite material has a relative density of 95% or more, in particular more than 97%, with respect to the theoretically achievable material density of all solid it contains.

According to the invention, the production of the bulk metallic glass composite material occurs by means of a powder-based, additive manufacturing method. The basic principle of a powder-based, additive manufacturing method preferably comprises at least the following steps.
1) First, a thin layer of a powder is generated.
2) Then, the powder layer is heated with energy-rich radiation, so that the individual particles of the powder layer connect, and in particular fuse, to one another in the heated area, whereby a contiguous material layer is obtained.
3) Optionally, in the next step, another powder layer can be applied onto the previously generated material layer.
4) Analogously to step 2), the additionally applied powder layer is heated with energy-rich radiation, so that the particles of the powder in the heated area connect, and in particular fuse, into another contiguous material layer.
5) Optionally, a bulk metallic glass composite material of any thickness can be obtained by repeated generation and stacking of any number of further material layers.
6) After completion of the component, loose, non-heated powder that is not part of a material layer can be removed from the component.

Preferably, in step 1), the layer of a powder is applied to a base plate, also called the construction plate. The layer thickness of the thin layers of the powder or the powder mixture is preferably in the range of 5 μm to 500 μm. The base plate, or the construction chamber in which the powder layer is applied, can be optionally heated. The application of the powder layer preferably occurs by means of squeegees or rollers.

In step 2), the previously generated powder layer is heated. Preferably, the heating occurs selectively by means of energy-rich radiation in a predefined area. In a preferred embodiment, the generation of a single material layer from a single powder layer already constitutes a powder-based, additive manufacturing method. Depending upon the specific design, various powder-based, additive manufacturing methods may be used. If the powder is heated by means of laser radiation, this is called Selective Laser Melting (SLM). By contrast, if the powder is heated by means of electron radiation, this is called Electron Beam Melting (EBM). The EBM method is preferably performed under a vacuum. SLM is preferably performed under an inert gas atmosphere, e.g., a nitrogen or argon atmosphere. The laser radiation used in the SLM method is not further limited according to the invention and may have different wavelengths and outputs. Preferably, the laser radiation used has a wavelength in the range of 400 nm-10 μm, preferably in the infrared range of 800 nm-10 μm. The laser radiation may be pulsed or continuous. Particularly preferably, the laser radiation is generated by a Yb fiber laser with a wavelength in the infrared range, e.g., approximately 1060 nm. For example, a wavelength of approx. 530 nm can be used for frequency doubling of the Yb fiber laser. The laser output is also not further limited according to the invention. However, the laser power is preferably high enough that at least one phase of the bulk metallic glass can be melted. Preferably, the heating of the powder layer occurs selectively by means of energy-rich radiation in a predefined area.

In step 3), a further powder layer is generated analogously to the first layer and is arranged on the first material layer. The layer thickness of the thin layers of a powder or of a powder mixture is preferably in the range of 5 μm to 500 μm.

In step 4), the additional optional powder layer is heated with energy-rich radiation. The additional material layer obtained is preferably not only self-contiguous but also connected to the underlying material layer. The heating of the additional powder layer preferably occurs selectively in predefined areas.

Through repeated application of additional material layers, a bulk metallic glass composite material can be obtained, which has a significantly higher thickness than the maximum casting thickness. Heating is preferably carried out selectively in steps 2), 4), and all additional optional steps with energy-rich radiation in a predefined area. As a result, individual material layers can be generated with complex contours. Through stacking of multiple material layers with complex contours, finished three-dimensional components can be produced from the bulk metallic glass composite material. The information regarding how an individual powder layer must be heated selectively in order to obtain a material layer is calculated by a computer. For this purpose, a virtual model of a component to be manufactured is disassembled in any number of cross-sections, the sum of which results in the finished component. Through selective heating of the respective powder layers according to a predefined shape contour, a finished three-dimensional component can preferably be assembled by means of the method, in particular a component that can be used directly and without after-treatment in a technical application.

In step 6), the loose powder is normally removed. Optionally, the composite material obtained or the component obtained may be treated after the completion of the procedure, e.g., by surface treatment such as sandblasting or hot isostatic pressing. Optionally, the component obtained can also be treated with subtractive methods such as grinding and milling.

In principle, devices for performing a powder-based, additive manufacturing method are usually constructed similarly. The systems and devices that can be used for the method are known to a person skilled in the art.

For use in the powder-based, additive manufacturing method, powders are preferably used as a precursor for the first phase. For use in the powder-based, additive manufacturing method, powders or network structures are used as a precursor for the at least one additional phase. When powders are used in the method according to the invention, the morphology of these powder particles can preferably include nearly spherical shapes, rods, ellipsoids, fibers, flakes, platelets, or mixtures of the aforementioned shapes. Nearly spherical shapes are understood to mean those in which at least 80% of the particles meet the following condition:

0.8≤dₘin/dₘₐₓ≤1.0;

wherein dₘᵢₙ is the minimum diameter and dₘₐₓ is the maximum diameter of a particle.

The powders used in the method can be prepared in a variety of ways. The suitable methods are known to a person skilled in the art of powder production.

In a preferred embodiment of the invention, the powders have a particle size distribution d₅₀ in the range of 1 μm to 200 μm. Preferably, the powders have a particle size distribution in the range of ≥10 μm to ≥45 μm or ≥20 μm to ≥65 μm, wherein the lower value of the value range gives the d₂ value and the upper value gives the d₉₀ value, respectively.

The respective powder can be measured as a dry dispersion by means of laser diffraction particle size analysis pursuant to ISO 13320:2009, and, from the measurement data, the volume distribution curve can be determined. From the volume distribution curve, the values d₂, d₅₀, and d₉₀ can be calculated pursuant to ISO 9276-2:2014.

Preferably, all powders used for the invention have a flowability that is sufficient to apply the powder with a squeegee as a homogeneous layer.

Preferably, the powder-based, additive manufacturing method comprises the use of a powder mixture of at least two powders. Preferably, at least a first powder of a bulk metallic glass and at least one additional powder are used for the method according to the invention. In a particularly preferred embodiment of the invention, a mixture of at least one powder and one or more network structures can be used in the powder-based, additive manufacturing method, wherein at least one powder of a bulk metallic glass is used in this embodiment. Within the scope of the invention, the powder or network structures can be used as a precursor for the at least one additional phase of the bulk metallic glass composite material. Depending on the configuration of the networks used and the exact use in the method according to the invention, the networks can lead to the mechanical properties of the bulk metallic glass composite material or the three-dimensional component being anisotropic. These network structures embedded in the composite material can be used in order to give the composite material or the resulting three-dimensional component direction-dependent properties in a targeted manner. For use in the powder-based, additive manufacturing method, a powder from the materials for the first phase as described above can be used as a precursor for the first phase. For use in the powder-based, additive manufacturing method, a powder from the materials for at least one additional phase as described above can be used as a precursor for the at least one additional phase.

In a particularly preferred embodiment, a powder mixture of a powder from a bulk metallic glass and at least one powder from a further material are used for the powder-based additive manufacturing method, wherein the at least one additional material corresponds to the material of the at least one additional phase.

Preferably, the powders used, in particular in the powder mixture, for use in the powder-based, additive manufacturing method, have a differentiated melting behavior under the influence of energy-rich radiation, in particular the same radiation. Energy-rich radiation may be electromagnetic radiation or electron radiation. In particular, the different powders for use in the powder-based, additive manufacturing method have various absorption coefficients for electromagnetic radiation. The electromagnetic radiation can preferably comprise infrared radiation. Infrared radiation is understood to mean electromagnetic radiation in the wavelength range of 800 nm-10 μm, e.g. 1064 nm. The differentiated melting behavior under the influence of electromagnetic radiation can be attributed to different transmission and/or reflection properties. In an alternative embodiment, the melting behavior under the influence of energy-rich radiation can also be due to other physical properties, e.g., different electrical or thermal conductivities. Through this use of powder materials with different interactions with electromagnetic radiation or by using powders with different conductivities, materials can be processed into bulk metallic glass composite materials that have similar melting points. This means that, for example, under the influence of laser radiation, the powder for production of the bulk metallic glass can melt while the powder for the production of at least one additional phase can remain solid. Preferably, the heating of the powders is done briefly enough and the dissipation of the heat is high enough so that only the powder for production of the first phase melts while the powder for production of the at least one additional phase remains partially or completely solid. In particular, it is preferred that the material, in particular a powder, for the production of the at least one additional phase at least does not completely dissolve in the melt of the material of the first phase.

An example of such a material combination with close melting temperatures is the commercial alloy AMZ4 by Heraeus Additive Manufacturing GmbH (melting point 915° C.) and copper (melting point 1085° C.). The melting temperatures of these materials are only 170° C. apart. If one were to attempt to produce a bulk metallic glass composite material from these materials by casting methods, the copper would melt or dissolve in the melt of the alloy.

Three-dimensional components can be produced in various ways from the bulk metallic glass composite material according to the invention. Preferably, the resulting component contains or consists of a bulk metallic glass composite material.

According to the invention, the three-dimensional component is not further limited in its geometry and expansion. Preferably, the three-dimensional body is designed without material transitions, i.e., as one piece. In a preferred embodiment, the three-dimensional form is massively solid and thus does not include any cavities. In another preferred embodiment, the three-dimensional body can have interior cavities, such as channels, ducts, etc.

In the simplest case, the three-dimensional component, which can be produced with the method according to the invention, consists of a single material layer which was generated by means of a powder-based, additive manufacturing method from a single powder layer.

In an alternative embodiment, a precursor for a three-dimensional component from the bulk metallic glass composite material according to the invention can be generated by stacking of an arbitrary number of material layers. This precursor from the bulk metallic glass composite material according to the invention, which can be considered a workpiece, can subsequently be processed with known manufacturing methods, such as subtractive methods (milling or cutting), to a finished three-dimensional component from the bulk metallic glass composite material according to the invention. Alternatively, a workpiece can also be further processed through thermoplastic shaping.

However, it is preferable to use the powder-based, additive manufacturing method according to the invention in parallel to the generation of the composite material in order to also generate a three-dimensional component. This means that when generating the respective material layers, the contours are selected such that the connected material layers already result in the finished three-dimensional component.

If a powder-based, additive manufacturing method is used for producing three-dimensional components, then, by comparison to other methods, three-dimensional components having particularly complex geometries or particularly large thicknesses above the maximum achievable casting thicknesses, also known as critical casting thicknesses, can be produced from bulk metallic glass composite materials.

More complex geometries can be produced with the powder-based, additive manufacturing method in particular in that several material layers of the composite material according to the invention are connected, wherein each material layer is generated through selective heating of a powder layer in a predefined area. Through the composition of consecutive material layers with complex contours, complex three-dimensional components can thus be generated. Typically, the individual material layers with complex contours are obtained in that a virtual model of the component is disassembled into a certain number of cross-sections, so that each individual cross-section through the component can be produced as a material layer.

In particular, three-dimensional components from a bulk metallic glass composite material having undercuts can be obtained with the method according to the invention. Undercuts are impossible or very difficult to achieve with casting methods, because the finished component cannot be removed from the casting mold. A simple example of an undercut can be a hook that cannot be removed from a single-part casting mold. For example, one-piece components with cavities are also possible with the method according to the invention. In particular, a component according to the invention can also comprise structures with a high aspect ratio. For example, the aspect ratio can be 20 or more. The aspect ratio is the ratio of the largest expansion direction of a structure to the smallest expansion direction of a structure. For example, lattice or network structures can be produced with the method according to the invention, which are not accessible with other processing methods for bulk metallic glass composite materials. For example, through powder-based, additive manufacturing methods, components can easily be produced from bulk metallic glass composite materials, which exhibit dimensions of 100-500 μm in at least one expansion direction, in particular in two expansion directions, while another, in particular a third, expansion direction exhibits dimensions of one centimeter or more.

A special advantage of the powder-based, additive manufacturing method is that the producible component is not limited to the maximum casting thicknesses in its expansion. In particular, the method offers the possibility of a flexible construction of components that are not possible with other processing methods for bulk metallic glass composites.

The invention further relates to a three-dimensional component from a bulk metallic glass composite material comprising a first phase containing a bulk metallic glass and at least one additional phase, characterized in that the bulk metallic glass composite material has isotropic mechanical properties and the melting temperatures of the first and the at least one additional phase are no more than 200° C. apart from each other.

In principle, the use of the bulk metallic glass composite material, which was produced according to the method according to the invention, is not further limited. In a preferred embodiment, the bulk metallic glass composite material can be used in the applications that are deemed by a person skilled in the art to also be suitable for bulk metallic glasses. Preferred applications of the bulk metallic glass composite material are those that require wear-free and/or high-strength components. Particularly preferred applications for the bulk metallic glass composite material are, for example, selected from gears, springs, housings, watch components, and medical technology applications (e.g., prostheses).

### Example

The following powders were prepared for the production of an exemplary bulk metallic glass composite material: 1) AMZ4 (a ZrCu—AlNb alloy, Heraeus Additive Manufacturing GmbH, Germany), 2) copper powder. The particle size d₅₀ of the AMZ4 fraction=22 μm and that of the copper powder particle d₅₀=25 μm. The two powders were processed into a homogeneous powder mixture, wherein this mixture contained 90 wt. % AMZ4 powder and 10 wt. % copper powder. Using selective laser melting (SLM), the powders were processed in layers into a bulk metallic glass composite material. The laser output was selected in such a way that the powder particles of the AMZ4 alloy melted, while the powder particles of copper remained solid. In this case, the laser output was P=50 W, the scan speed was 3000 mm/s, and the line width was about 45 μm. Using the specified parameters, a cube with an edge length of 1 cm was produced. From the sample obtained, a ground joint was prepared by making a cut through the cube with a diamond saw and grinding and polishing the cut surface. The ground joint surface was examined using optical microscopy. The result can be seen in FIG. 2. The dark areas are attributed to the first amorphous phase while the light areas represent the copper phase. In addition, a part of the obtained bulk metallic glass composite material was measured using DSC. For this purpose, a thin platelet of about 50 mg was cut off from the cube with a diamond saw. The DSC measurement was carried out with a heating rate of 20 K/min in a temperature range of room temperature to 650° C. The result of the DSC measurement is shown in FIG. 1. As can be seen, the measurement shows with increasing temperature an endothermic signal that is typical for the glass transition, followed by an exothermic signal that is typical for the crystallization process of the previously amorphous phase. This measurement serves as evidence that there is an amorphous phase in the bulk metallic glass composite material. In comparison, neither a glass transition nor a crystallization would have been detected in a DSC measurement of a crystalline metal.

### DESCRIPTION OF DRAWINGS

FIG. 1: DSC measurement of a bulk metallic glass composite material produced according to the invention.

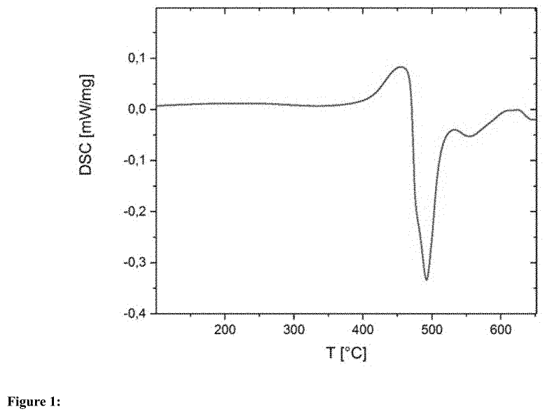

FIG. 2: Optical microscope image of a ground joint of a bulk metallic glass composite material. The dark areas show the first phase comprising a bulk metallic glass and the light areas show an additional phase of a metal (here, copper), which is dispersed in the first phase.

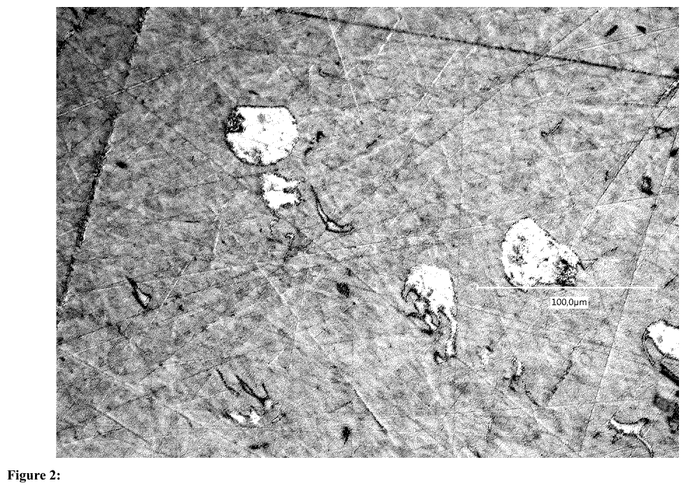

1. Method for the production of a bulk metallic glass composite material, wherein the bulk metallic glass composite material has at least two phases, wherein the first phase is a bulk metallic glass and wherein at least one additional phase is selected from the group consisting of crystalline metal, metallic glass, non-metallic glass, and ceramic,
characterized in that the production occurs by means of a powder-based, additive manufacturing method.

2. Method according to claim 1, characterized in that a mixture of at least two powders is used for the powder-based, additive manufacturing method, wherein at least one powder consists of a bulk metallic glass.

3. Method according to claim 1, wherein the morphology of the powder for the powder-based additive manufacturing method comprises spherical forms, fibers, flakes, platelets, or combinations thereof.

4. Method according to claim 1, wherein at least one powder of a bulk metallic glass and at least one powder of a crystalline metal are used for the additive manufacturing method.

5. Method according to claim 1, wherein the powder-based additive manufacturing method is selected from the group consisting of selective laser melting (SLM) and electron beam melting (EBM).

6. Method according to claim 1, wherein the powders used for the additive manufacturing method comprises a differentiated melting behavior under the influence of energy-rich radiation.

7. Method according to claim 1, wherein the materials of at least two powders have different absorption coefficients for energy-rich radiation and/or different thermal conductivities.

8. Method according to claim 1, wherein the bulk metallic glass composite material has isotropic mechanical properties.

9. Method according to claim 1, wherein the first phase and at the least one additional phase have melting points that are no more than 200° C., in particular no more than 150° C., apart from one another.

10. Bulk metallic glass composite material comprising at least two phases, wherein the first phase is a bulk metallic glass and wherein at least one additional phase is selected from the group consisting of crystalline metal, metallic glass, non-metallic glass, and ceramic,
characterized in that the bulk metallic glass composite material has isotropic mechanical properties, and the melting temperatures of the first and the at least one additional phase are no more than 200° C. apart from each other.

11. Three-dimensional component made of a bulk metallic glass composite material according to claim 10.
